(19) United States
(12) Patent Application Publication
(10) Pub. No.: US 2010/0054635 A1
(43) Pub. Date: Mar. 4, 2010

(54) POUCH METHODS AND APPARATUS FOR POUCH CONDITIONING

(75) Inventors: Jeffrey D. Wintring, Florence, KY (US); Sima Paunesku, Cincinnati, OH (US)

Correspondence Address: WOOD, HERRON & EVANS, LLP, 2700 CAREW TOWER, 441 VINE STREET, CINCINNATI, OH, 45202, US

(73) Assignee: R.A. Jones & Co. Inc., Covington, KY (US)

(21) Appl. No.: 12/553,551

(22) Filed: Sep. 3, 2009

Related U.S. Application Data
(60) Provisional application No. 61/190,949, filed on Sep. 4, 2008.

(51) Int. Cl. B65D 33/02; B31B 1/25; B31B 1/90

(52) U.S. Cl. 383/35; 493/212; 493/241; 383/105; 383/119

(57) ABSTRACT

An improved pouch has a crimped or squeezed mouth region to facilitate pouch opening and hold open during filling. Mouth edge curls are disclosed for enhancing mouth opening. Roller nip and crimp roller apparatus is disclosed. Pouch conditioning methods are disclosed.

### RELATED APPLICATION

Applicant claims the benefit of the filing date of Sep. 4, 2008 of its U.S. provisional patent application Ser. No. 61/190,949, which application is expressly incorporated herein by reference.

### FIELD OF THE INVENTION

This invention relates to pouch forming, filling and sealing, and more particularly to preparing and handling pouches and the mouths thereof to enhance subsequent opening for filling, whether in bandolier or individual pouch applications.

### BACKGROUND OF THE INVENTION

Pouches are formed from a variety of relatively thin materials, typically by folding an elongated web, then transversely sealing together the folded plies at intervals (corresponding to pouch pitch) to form sealed side seams with open mouths therebetween at the pouch tops. As so prepared, an indefinite length or “bandolier” of serially attached pouches is formed. Such a bandolier can be directed as a train of pouches through opening, filling, sealing and cutting apparatus or stations, or individual pouches can be cut, one from the other, gripped at the side seams and transported as individual pouches through opening, filling and sealing operations. One such apparatus for so handling individual pouches is applicant's co-pending U.S. patent application Ser. No. 11/688,205, filed Jan. 29, 2007, published on Aug. 9, 2007 under No. US 2007/0180794, both application and publication incorporated herein by reference as if fully set out herein.

Because of web stiffness characteristics, including the relative flimsy or thin nature of typical pouch material, the pouches do not open robustly when air is directed at the “mouth” of the pouch. The web will sometimes fold over on itself and not open due to the air not being able to find a path into the mouth. Another problematical situation is presented when the pouch opens but re-closes immediately after being opened due to web “memory” which is not effectively resisted by a material stiffness too low to overcome such memory.

Prior methods of pouch opening are varied. One such method biases the web material at the mouth of the pouch. A forming guide “curls” the web on one or both sides of the pouch mouth such that the internal pouch material surfaces flair away from each other. The result is a lead-in or path into the pouch for the pressurized air that will do the opening. The guide work required for this method is difficult to setup and can result in a wrinkle being introduced into the web.

Another method involves making one side of the pouch, termed a “lip”, higher than the other. This configuration allows the pressurized air to have a surface that helps separate and direct the air into the pouch.

Neither of these methods addresses the issue of material stiffness and memory which may result in the pouch re-closing.

Accordingly, it is desired to enhance the opening of pouches, presented either in a train or bandolier or as cut and individually presented continuously or intermittently to pouch opening stations.

It is further desired to provide improved pouch handling apparatus for producing pouches whose mouths are more reliably and consistently opened for filling.

It is further desired to provide improved pouch structure for enhancing reliable and consistent mouth opening for filling.

### SUMMARY OF THE INVENTION

A preferred embodiment according to the invention contemplates crimping the pouch plies in a mouth region, thus increasing the stiffness of the pouch at its mouth, which tends to robustly open and remain open when an opening airstream is applied thereto.

One embodiment of the invention includes a nip defined by a pair of operably opposed rollers with each roller having raised surfaces that run parallel to each other and are located about the circumference of preferably each roller. The doubled pouch web is passed between the rollers and is “crimped” between them under some pressure, which may be supplied by biasing one or both rollers into the nip such as applied by a spring. The rollers can be driven or non-driven. The action of passing the web, in particular the region of pouch mouth, through the nip between the rollers imparts a crimp pattern comprising a series of ridges and valleys into the web at the mouth area or region and preferably just below the upper edges of the mouth. These ridges and valleys cause each ply of the affected web at the pouch mouth to have a greater stiffness much like a corrugated material. This increased stiffness resists the otherwise tendency of the pouch plies to fold over and obstruct the opening action of the air when pouches are presented to an opening station. This stiffness allows the pouch tops to “pop” open robustly when opening air is blown into the pouch, and effectively resists any ply memory which may tend to urge the mouth to prematurely close. In addition, the web will naturally curl outwardly on both sides of the pouch mouth above the crimp and provide a pathway for the pressurized opening air. Once opened, the now higher material stiffness overcomes the tendency of the pouch to re-close.

This method and apparatus is easy to setup, do not impart un-wanted wrinkles into the web, and the apparatus can be disengaged by simply pulling or moving the rollers away from the web. The method can also be used with or without an extended “lip” or ply extension from one of the pouch plies above or within the crimp.

Other variations of this method and apparatus are possible. The use of one roller with a back-up surface defining a nip is possible as well as using two or more rollers in tandem or individually sequencing one after each other. For example, one roller could be oriented on one side of a pouch with another crimping roller or rollers downstream on another side of the pouch. Additionally, the rollers can be smooth with no crimp pattern to achieve only the “curl” at the mouth and to limit the amount of induced stiffness.

These and other objects and advantages will be readily appreciated from the following detailed written description and from the drawings in which:

### BRIEF DESCRIPTION OF THE DRAWINGS

FIG. 1 is an elevational view of pouches in a pouch bandolier running through a crimping nip according to the invention;

FIG. 1A is a diagrammatic plan view along lines 1A-1A of FIG. 1 of a nip according to the invention, and defined by two rollers having a crimping pattern;

FIG. 1B is a diagrammatic plan view of a nip according to the invention defined by two rollers, one having a crimping pattern in a peripheral surface and one a smooth peripheral surface;

FIG. 1C is a diagrammatic plan view of a nip according to the invention having two rollers, each with a smooth peripheral surface;

FIG. 2 is a perspective view of the invention as shown in FIGS. 1 and 1A;

FIG. 3 is a perspective view of an individual pouch formed as in FIGS. 1, 1A and 2;

FIG. 4 is a diagrammatic cross-sectional view taken along lines A-A of FIG. 2 but modified to show one crimp pattern surface and one smooth surface of opposed rollers as in FIG. 1B;

FIG. 5 is a diagrammatic cross-sectional view also taken along lines A-A of FIG. 2 but modified to illustrate a nip formed by two smooth surface opposed rollers as in FIG. 1C; and

FIG. 6 is a perspective view similar to FIG. 3 but illustrating a pouch having mouth edges curled way one from the other and a crimp in each pouch ply spaced from said mouth edges.

### DETAILED DESCRIPTION OF THE INVENTION

Turning now to the drawings, it will be appreciated that pouches described herein can be made from a variety of suitable pouch materials, including but not limited to synthetic materials, metal or metallized materials, aluminized materials and any other suitable materials as desired. It will also be appreciated that similar components of the embodiments in the drawings are designated with identical numbers.

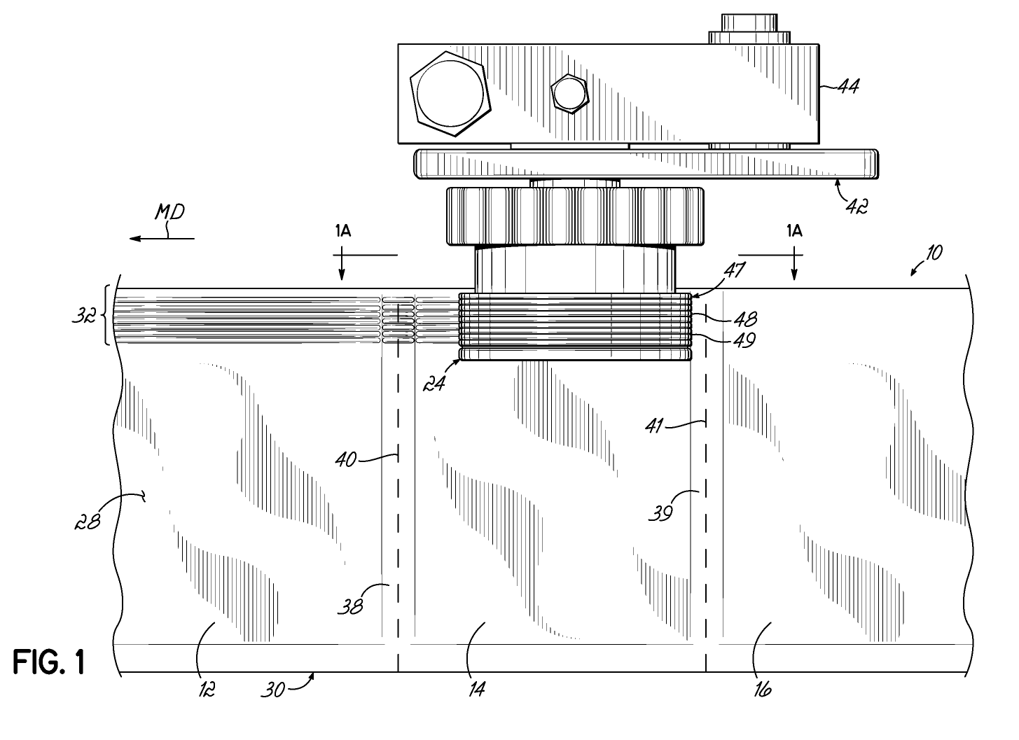

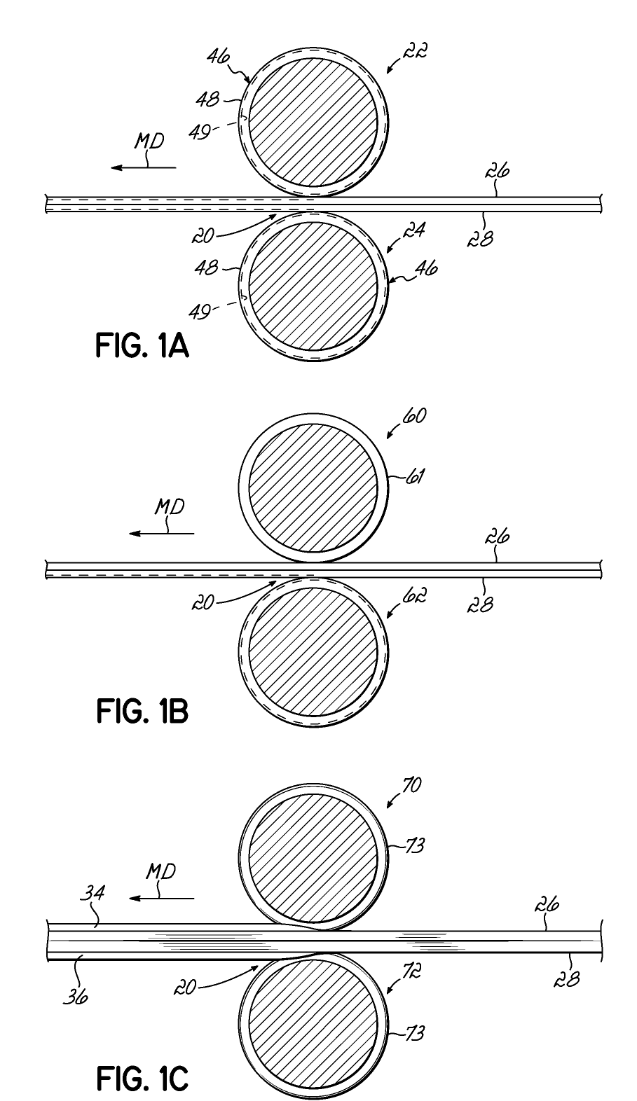

FIGS. 1 and 2 illustrate one embodiment of the invention in which a bandolier 10 of serially connected pouches 12, 14, 16, for example, are transported through a nip 20 defined by two rollers 22, 24. The bandolier comprises at least two adjacent pouch plies 26, 28 (see FIGS. 1A, 1B, 1C) folded about a fold line 30 along which is the pouch bottom. Each pouch has a mouth region 32 defined by the adjacent plies 26, 28. Each mouth region 32 terminates in an edge 34, 36 as indicated in the FIGS.

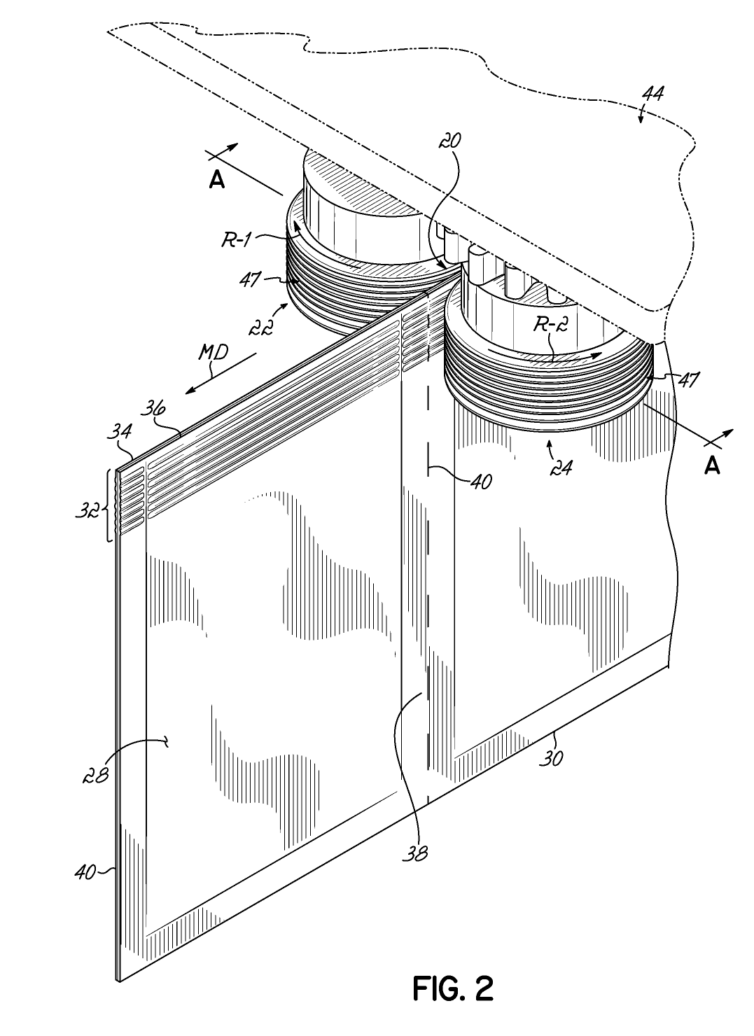

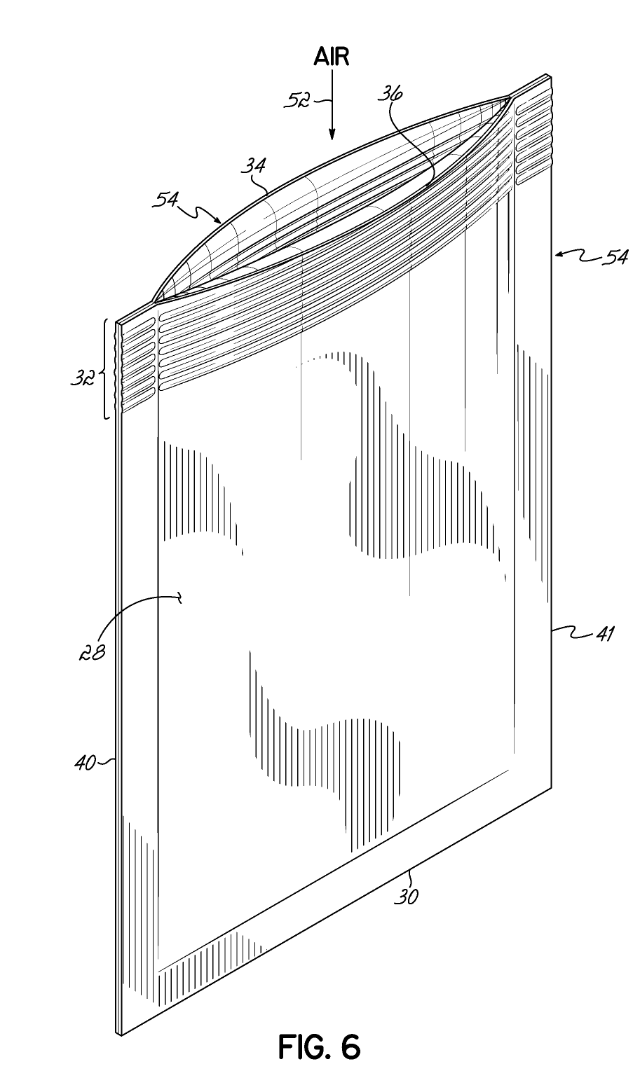

Each pouch is defined by a sealed side seam 38, 39 formed transversely across plies 26, 28. Eventually, and either before or after pouch opening or filling, the pouches 12, 14 and 16 are separated about respective cut lines 40, 41, for example, to form individual pouches such as those shown in FIGS. 3 and 6.

Preferably while in bandolier form 10, the pouches are transported through nip 20 in the machine direction MD, with plies 26, 28 at the mouth region 32 squeezed by an appropriate pressure presented by the nip such as between rollers 22, 24.

Rollers 22, 24 are rotatably mounted via a frame member 44 and any suitable roller drive or support structure 46 as may be desired. One, both or neither of the rollers 22, 24 can be driven. Each counter-rotate with respect to the other as plies 26, 28 are transported therebetween, and as illustrated by the direction arrows R-1, R-2 of FIG. 2. Rollers 22, 24 are preferably biased with respect to each other to form nip 20. One or both rollers 22, 24 can be biased toward the other.

FIGS. 1, 1A and 2 illustrate one preferred embodiment of the invention for conditioning a pouch 50 as shown in FIG. 3. In FIGS. 1 and 2, two opposed rollers 22, 24 each have a peripheral surface 46 defining a crimp pattern 47 of a plurality of parallel ridges 48 and valleys 49 as illustrated.

When plies 26, 28 are transported through nip 20, a corresponding crimp pattern is applied in the respective plies. It will be appreciated that the ridges 48 and valleys 49 of the rollers 22, 24 may be offset one from the other or may be directly opposed, all to form a crimp pattern in mouth region 32 and preferably up to the mouth edges 34, 36.

A resulting pouch 50 (FIG. 3) whether individually cut, then opened, or a plurality of pouches 50 still in bandolier form for opening and filling (not shown) is thus formed.

The resulting crimped mouth region 32 in this pouch 50 is of such a stiffness that it robustly opens and remains open when an airstream 52 is directed onto the mouth. Edges 34, 36 do not tend to reclose after opening due at least in part to this increased stiffness.

An alternative pouch 54 (FIG. 6) is likewise formed by drawing plies 26, 28 through a nip 20, but in a slightly elevated path with respect to rollers 22, 24. In this embodiment, the crimp pattern of the rollers is disposed beneath, or spaced slightly from the mouth edges 34, 36. The crimp in the plies is still in mouth region 32, but is so below the edges 34, 36 that the result is a curling of the respective edges 34, 36 outwardly and away from each other as in FIG. 6. This forms an even wider mouth 56 facilitating opening of the individual or bandolier formed pouch mouths.

Further embodiments of the invention are illustrated in FIGS. 1B, 1C, 4 and 5.

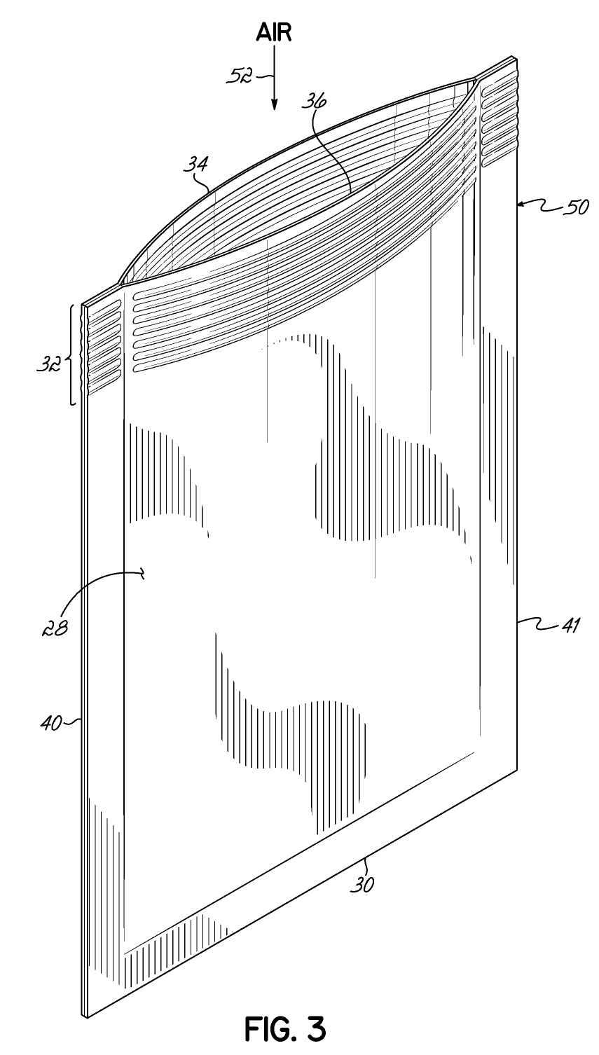

FIG. 1B and FIG. 4 illustrate one embodiment where a nip 20 is formed by rollers 60, 62. One roller 60 has a smooth peripheral surface 61 while roller 62 is like that of crimp pattern roller 24 in FIG. 1A. This embodiment results in an application of a crimp pattern 48, 49 of roller 62 to ply 28, while ply 26 remains substantially smooth. Since the crimp is applied up to edges 34, 36, the pouch mouth remains relatively straight (FIG. 4).

This configuration produces a pouch like that of FIG. 3, with the exception of one ply remaining smooth. Nevertheless, the crimping of one ply so stiffens the mouth of such a pouch that opening and remaining open is enhanced. And further, if the plies are elevated through nip 20 of FIG. 4, the top edges 34, 36 will tend to curl away one from the other as illustrated in FIG. 1, but with one ply remaining smooth.

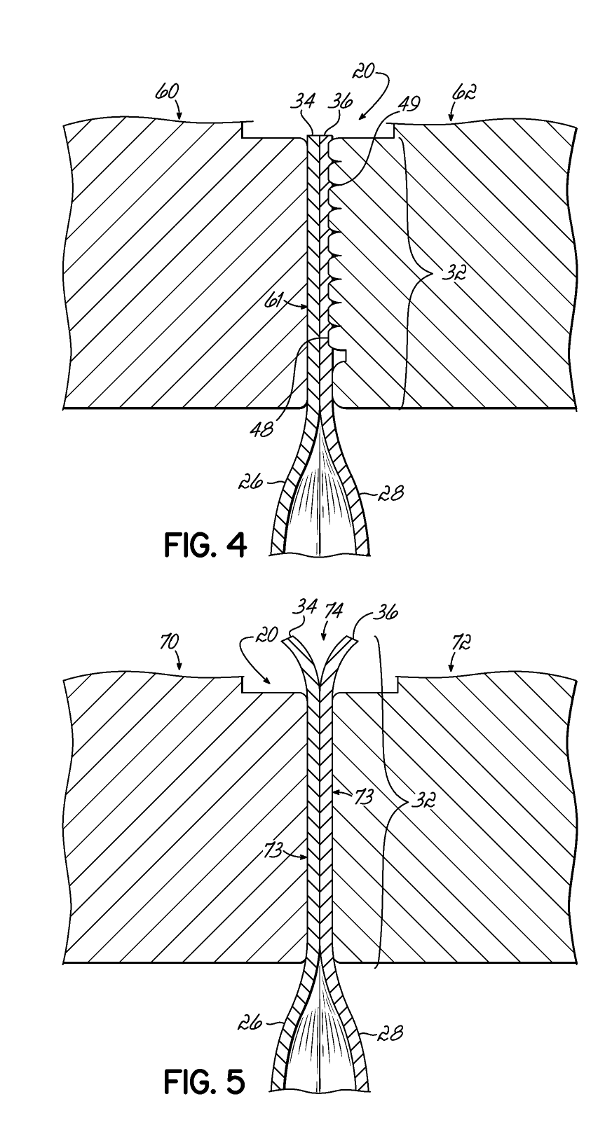

FIG. 1C illustrates yet another embodiment of the invention wherein nip 20 is defined by two smooth rollers 70, 72, each having a smooth surface 73. Preferably, the plies 26, 28 passing nip 20 of FIG. 1C are elevated so the plies are squeezed between respective smooth surfaces 73 in mouth regions 32, but in a part of region 32 spaced from edges 34, 36 as shown in FIG. 5. Edges 34, 36 are thus curled, as shown in FIG. 5, one away from the other to form an open area 74 between plies 26, 28 facilitating further opening of the pouch mouth by an air stream as desired. This curl, accompanied by the conditioning of the plies 26, 28 in the nip, facilitates and enhances opening of such a pouch. This embodiment then, in use, is partly illustrated in FIG. 6 with the exception that the plies 26, 28 in mouth region 32 are smooth, rather than crimped in a pattern as in FIG. 6.

It will be appreciated that while nip 20 is shown in the embodiments herein formed by two opposed rotatable rollers, the invention contemplates a single roller forming a nip with opposed back-up surfaces of a variety of expedients.

Accordingly, the invention contemplates a pouch having a pressed or squeezed mouth region in either a pattern format or smooth to strengthen the mouth and to facilitate opening reliably and consistently. Pouch plies can be squeezed to cause an edge curl widening the mouth for opening. Preferred apparatus includes a roller defined nip for imparting a crimp to a pouch mouth region and to squeeze the pouch mouth region to form a curl in the mouth edges whether or not a crimped pattern is formed in the pouch. Rollers can have crimped or smooth peripheries. A preferred method according to the invention includes running pouch plies through a nip in the pouch mouth region either to impart a crimp thereto to facilitate mouth opening and hold open or to cause mouth edges to curl and facilitate mouth opening, or both.

These and other alternatives and modifications will be readily apparent to one of ordinary skilled in the art without departing from the scope of the invention and applicant intends to be bound only by the claims which are made in this application.

What is claimed is:

1. Apparatus for conditioning pouches to facilitate pouch opening and comprising:
at least one roller oriented to engage a pouch ply proximate a pouch mouth;
said roller having a periphery defining a crimp pattern for applying a crimp in said pouch ply to stiffen said ply at said pouch mouth.

2. Apparatus as in claim 1 further including at least two rollers defining a crimping nip through which pouches may be conveyed.

3. Apparatus as in claim 2 wherein each roller has a respective peripheral surface defining a crimp pattern.

4. Apparatus as in claim 1 including a back-up surface, said at least one roller and said back-up surface defining a nip through which pouches may be conveyed.

5. Apparatus as in claim 1 including two opposed rollers wherein one of said two opposed rollers has a smooth surface in part defining said nip with said at least one roller.

6. Apparatus as in claim 1 wherein said pouch mouth includes a mouth region terminating in opposed upper edges, said at least one roller oriented to engage said pouch ply in said region spaced from said edges.

7. Apparatus as in claim 6 wherein said pouch has a mouth region terminating in opposed mouth edges, said pouch ply engaging surface of each roller oriented to engage a mouth region of a pouch in a position spaced from said opposed mouth edges to cause said edges respectively to curl one away from another.

8. Apparatus for conditioning pouches having a mouth region terminating in opposite edges and comprising:
two opposed rollers defining a nip,
each roller having a smooth peripheral surface oriented to engage said mouth region spaced from said opposed edges, as a pouch is moved through said nip to provide an outward curl in respective ones of said opposed edges.

9. A pouch comprising:
two opposed plies defining a mouth region terminating in respective opposed mouth edges; and
a crimp pattern in at least one ply of said mouth region.

10. A pouch as in claim 9 including a crimp pattern in both plies of said mouth region.

11. A pouch as in claim 9 wherein said crimp pattern is oriented in said mouth region in a position spaced from said opposed mouth edges.

12. A pouch comprising:
two opposed plies defining a mouth region terminating in respective opposed mouth edges, said edges curled away one from the other, respectively.

13. A pouch as in claim 12 further including a crimp pattern in at least one of said opposed plies oriented in said mouth region.

14. A method of treating pouches defined by at least two opposed plies to facilitate opening of a pouch mouth and comprising the steps of:
forming a crimp pattern in at least one ply of a pouch proximate the pouch mouth.

15. A method as in claim 14 including the further step of forming a crimp pattern in said two opposed plies on respective sides of a pouch mouth.

16. A method as in claim 15 including conveying a pouch between two rollers defining a crimping nip and forming a crimp pattern in at least one ply of said pouch proximate said pouch mouth.

17. A method as in claim 14 including the further step of forming a curl in said at least one ply proximate a crimp pattern therein and in response to said crimp pattern forming.

18. A method of forming pouches from at least two adjacent pouch plies defining a pouch mouth to facilitate opening of said pouch mouth and comprising the step of squeezing said plies together in a mouth region proximate said mouth.

19. A method of treating pouches to facilitate opening of a pouch mouth and comprising the steps of:
conveying panels of a pouch through a nip; and
thereby forming a curl in at least one of said panels extending in a direction away from said mouth.

20. A method as in claim 19 including the further step of forming a crimp pattern in a part of said pouch proximate said curl.
